(19) United States
(12) Patent Application Publication
(10) Pub. No.: US 2009/0235359 A1
(43) Pub. Date: Sep. 17, 2009

(54) METHOD AND SYSTEM FOR PERFORMING SECURITY AND VULNERABILITY SCANS ON DEVICES BEHIND A NETWORK SECURITY DEVICE

(75) Inventors: Melih Abdulhayoglu, Montclair, NJ (US); Egemen Tas, Jersey City, NJ (US); Igor Seltskiy, Princeton, NJ (US); Vadim Lvovskiy, Odessa (UA); Vadim Klimov, Odessa (UA)

Correspondence Address: RICHARD JEREMY ROWLEY, 525 Washington Blvd., Suite 1400, Jersey City, NJ, 07310, US

(73) Assignee: Comodo CA Limited, Salford (GB)

(21) Appl. No.: 12/188,602

(22) Filed: Aug. 8, 2008

Related U.S. Application Data
(60) Provisional application No. 61/035,935, filed on Mar. 12, 2008.

(51) Int. Cl. G06F 21/00

(52) U.S. Cl. 726/25

(57) ABSTRACT

A method and system of performing vulnerability and security scans on an internet connected device where the device is behind a network security device such as a firewall. The method is performed by having an agent that is local to the device to be scanned create a VPN connection with a scanning server and then performing the scanning over the VPN. The connection is terminated at the end to free up system resources.

### CROSS-REFERENCE TO RELATED APPLICATION

This application claims the benefit of provisional application Ser. No. 61/035,935, filed Mar. 12, 2008, which is incorporated entirely herein by reference.

### BACKGROUND

Security and vulnerability scanning services provide valuable information about the security of a network, potential threats to the network, and other problems associated with devices and computers connected to a network. Scanning services offer assistance in locating and remedying vulnerabilities and security-holes in a variety of devices, including, but not limited to, computers connected to a network, servers, routers, firewalls, and other peripheral devices (each of these are referred to herein as a “device”). Scanning services are vital in ensuring the safety and security of consumers while conducting online transactions.

In some cases, vulnerability scanning services are mandated in order to do online business. The PCI counsel requires online merchants to receive scanning services prior to accepting credit cards online. Any merchants that have not received proper scanning may not process credit card payments. If a company is large enough, then PCI scanning must be performed daily. Because of the significant amount of scanning required and the complexity of the PCI and other scanning requirements, most merchants turn to a third party scanning provider who can perform the services remotely.

Third party scanning services operate by having a scanning customer specify to the scanning server a device that requires vulnerability scanning. This is usually done by providing information such as an IP address or domain name to a third party scanning server. The scanning server then initiates a scan over the Internet by barraging the IP address or domain name with simulated attacks. Upon completion of the simulation, the scanning server delivers a report detailing any security flaws detected to the scan requester. Many scanning service providers include detailed information on how to remedy the vulnerability and some even offer remediation services.

One of the biggest obstacles in performing scanning services is scanning devices connected to the internet that are behind a network security device such as a firewall. The problem is that any device connected through a network security device is not actually visible to the scanning server. The user cannot simply specify an IP address or domain name and expect to achieve adequate results. If the scanning service tries to scan the device while it is behind the network security device, the scan will actually occur on the network security device instead of on the device that the customer wants scanned. Scanning devices behind a network work device is important in case of primary domain failure, portable computers, or in order to ensure multi-hierarchal safety. Because of the strict guidelines of vulnerability scanners and the regulations and industry standards surrounding vulnerability scanning, there is a real need for an efficient method of scanning devices that are located behind a network security device.

One method previously used to overcome this limitation is to connect to the device that requires scanning through an established VPN connection and then perform the scanning services on the device directly over the established VPN. VPNs are a well known system for connecting to computers through firewalls and have been described in U.S. Pat. Nos. 7,197,550, 6,662,221, and 6,980,556, all of which describe methods for automated creation of secure VPN connections.

The problem with the current known VPN arrangement for providing scanning services is that the VPN connection must be established and maintained on the device that needs to be scanned prior to the initiation of the vulnerability scan. In addition, if daily scanning is necessary, the VPN connection must be permanently established and not disconnected. This is inefficient and not practical as a permanent VPN connections wastes bandwidth and severely limits the total number of computers that may be scanned by each scanning server. In addition, some devices may not support a VPN connection or allow any third party software to be installed. A VPN connection may be forbidden on the device by manufacture, design, or by the security policies set by a network administrator. These devices still require scanning services, but cannot use known methods.

Another solution in the industry has been to sell the scanning software outside of the separate scanning server and then let users run the scan on their local network. This is inefficient as updates to the security scans need to be made regularly. As threats change and grow, there is a strong need to keep all of the scanning services located in a single location so that the scanning services can be altered quickly in order to respond to changing needs. In addition, local scanning requires customers to have knowledge of scanning practices and a computer or server dedicated to the software. This wastes valuable local system resources for daily scanning that should be provided by the third party scanning service. These resources are often more efficient if allocated to other tasks.

A third party scanning provider that performs scans over the Internet is usually preferable over an internal scanning service as a third party can provide extra assurance to the public that the scans have been performed in a professional and expert manner. A third party scanner ensures the public that the scans performed and the results obtained are legitimate and not manipulated internally in order to achieve the necessary security compliance. Most companies already use third party scanning for its external devices so having internal scanning is a duplication of services and is inefficient.

Thus, there is a real need for a method and system that allows a party to perform or receive vulnerability scanning services on devices that are behind a network security device in a manner that is not restricted to an established VPN and that can be performed on-demand rather than through a permanent server connection.

### SUMMARY

The current application discloses a method of performing security scanning services over the Internet on devices that are protected by a firewall or other network security device. The invention discloses that an agent (a computer program) on the local intranet of the device to be scanned establishes a secure connection to the scanning server using a VPN tunnel. The agent can establish the VPN tunnel by having a user manually initiate the connection, by automatically or manually downloading instructions for the agent from a server outside of the network, or by including the instructions to start a VPN connection directly in the agent's software or in a database or instruction file that is shipped with the agent. Upon activation of a VPN initiation request, the agent automatically establishes the VPN connection using any known method, such as through the methods listed in U.S. Pat. Nos. 7,197,550, 6,662,221, and 6,980,556. After the VPN connection is established, the agent then requests the scanning services from a scanning server. Upon receipt of the scanning request from the agent, the scanning services are initiated over the Internet on the devices that require scanning over the VPN.

In one embodiment of the invention, an agent on a computer establishes the VPN connection with the scanning server. Through the VPN connection, the scanning server is assigned an IP address associated with the intranet on which the device requiring scanning is located during or after the VPN tunnel has been established. The IP address can be assigned by having the agent configure the network bridge or set up enabling the Proxy ARP for the IP address being assigned. As a result, the IP address of the scanning server appears to be a local IP address in relation to the device requiring scanning. The scanning server can be treated as a local computer and can run the scanning services on all of the devices connected to the local network without interference from the network security device. Once the scanning services are complete, the VPN connection is terminated in order to free system resources and allow the scanning server to connect to other networks.

In a second embodiment, after establishing the VPN connection, the agent is assigned an IP address (or multiple IP addresses). The assigned IP addresses are IP addresses associated with the scanning server's network. The scanning server then initiates scans on any devices on the agent's network that needs to be scanned. During the scan, all packets sent from the scanning server are sent to the agent instead of directly to the device. The agent then forwards the packets using DNAT. Replies to the scan by the device are sent back from the device being scanned to the agent and then forwarded by the agent to the scanning server.

The scanning services may be performed in parallel for multiple intranets by having a mediator server automatically select a single scanning server from a group of scanning servers where the single scanning server is currently not performing a scan. Alternatively, for the first embodiment, the agent can automatically bring up the scanning software on a virtual private server (“VPS”) and then have each agent requesting scans connect to the VPS.

Scanning speeds can be increased by having the agent configured to connect to multiple scanning servers and allowing each scanning server to run simultaneous scans on different devices. Alternatively, a mediator server can assign to each scanning server a separate set of IP addresses associated with devices that are in the scanning queue and then have each scanning server perform scans on the various connected devices.

### BRIEF DESCRIPTION OF THE FIGURES

FIG. 1 depicts a diagram of how the method and system operated

FIG. 2 depicts a flowchart of an embodiment of the invention

FIG. 3 depicts a flowchart of a second embodiment of the invention

FIG. 4 depicts a diagram of the second embodiment of the invention.

FIG. 5 depicts a diagram of how the invention can be used to increase scanning speeds on networks contain more than one device. FIG. 5 also depicts how the invention can be used with large enterprises.

FIG. 6 depicts a diagram of how the invention can be used to increase scanning speeds on networks contain more than one device.

### DETAILED DESCRIPTION

The following description includes specific details in order to provide a thorough understanding of the present method and system of performing security and vulnerability scanning services on devices behind network security devices. The skilled artisan will understand, however, that the products and methods described below can be practiced without employing these specific details, or that they can be used for purposes other than those described herein. Indeed, they can be modified and used in conjunction with products and techniques known to those of skill in the art in light of the present disclosure.

Reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

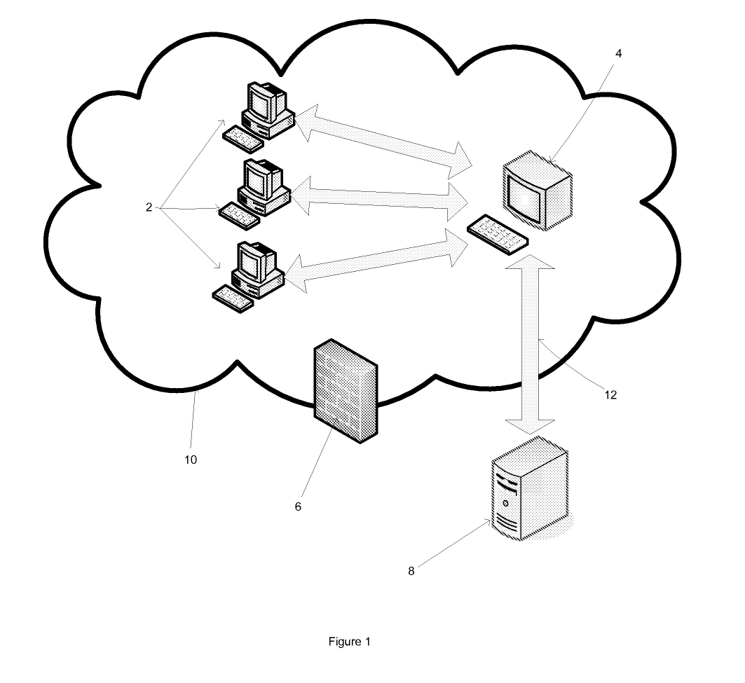

Referring now to FIG. 1 and 2, at least one device 2 on a network 10 that is behind a network security device 6 is going to be scanned or tested for security and vulnerability issues. The devices to be scanned 2 could be servers, computers, firewalls, printer servers, multi-functional devices, network attached storage, routers, switches, TCP enabled PBX systems, VOIP systems, or any other devices or combination of devices that can be connected to the network and scanned for vulnerabilities. The network security device 6 is typically a firewall but can be any network security device that limits access to the network on which the devices to be scanned are located, including, but not limited to a network proxy or NAT. In Step 101, an agent 4 that is also behind the network security device 6 initiates a VPN connection 12 to the scanning server 8. The agent 4 can be installed and running on the device to be scanned 2 or on a separate computer or terminal on the same network as the device to be scanned. The agent 4 is software designed to automate the initiation of a VPN tunnel 12 and may also perform DNAT operations (as in the second embodiment disclosed herein). The agent 4 can range from a full stand-alone application to a single-purpose applet that has only one instruction: to initiate the VPN tunnel at a given time. The agent 4 can be configured to run automatically at a set time, upon system startup, can be executed manually by the user of the device on which the agent is being used, or may be initiated in any other known method of initiating a program.

A VPN tunnel 12 is a well known term of art and is any connection used to conduct private communications between two computer terminals. The VPN tunnel 12 can be any kind of VPN that will allow IP packets to travel through it, including, but not limited to, SSL, IPSEC, or p2p VPN. A scanning server is any computer, server, or other device located outside of the network that will is configured to run vulnerability scanning or security tests on devices. Typically, this is a server box with vulnerability scanning software, but could be a computer with a hacker on the other side that is testing security settings or a computer-like device that executes a single security test.

In step 101, the agent 4 is instructed to create the VPN tunnel 12 by obtaining and using settings and instructions on how to connect to the scanning server 8. These instructions can be stored within the agent 4 or may be retrieved from an outside server, the scanning server itself, from a file or setting within the agent itself, or from any other location. Alternatively, the configuration file and certificate for creating the VPN can be downloaded from a website via HTTPS (or another method of transport) and then the login information can be inserted into the configuration file via a string substitution command by the agent. The exact configuration of how the agent executes and initiates the VPN connection would depend on the VPN tunnel being used. Instructions may be entered manually by the user and then stored for later use.

One example of how the agent enables the VPN connection is to have the agent contain an OpenVPN client, access OpenVPN settings, and download a certificate for connecting to the OpenVPN server. The agent would start the OpenVPN client which would read the settings and connect to the OpenVPN server.

In step 102, the scanning server 8 announces itself to the local network and is assigned an IP address within the local network 10. The IP address is assigned by having the agent 4 configure the network bridge per any known method of configuring a network bridge or by having the agent activate or enable a Proxy ARP for the IP address being assigned. Once the scanning server 8 is assigned an IP address within the local network 10, the scanning server 8 appears to be part of the local network 10 on which the devices to be scanned 2 or the agent 4 are located. Any known method may be used to assign the IP address and the invention is not limited to the two methods of IP address assignment described above. Once the scanning server 8 is assigned an IP address, the scanning server is considered to be part of the local network 10 and can act just like a server on the network.

In Step 103, the scanning server 8 then performs the security and vulnerability scanning services behind the network security device 6 through the VPN tunnel 12 using the assigned IP address.

If multiple devices on the local network 10 require scanning, the scanning server 8 can accept a list of IP addresses associated with the devices to be scanned 2 and can use the list perform the scanning services on each listed IP address. The generation, creation, distribution, and use of the list of IP addresses can be done in any known manner, including, but not limited to, maintaining a static list, searching the network for attached devices, or by manually feeding the IP addresses to the scanning server. The list can be stored directly on the scanning server, provided over the VPN tunnel 12, or provided through a network management interface which then sends the list to the scanning server 8. Distribution of this list of IP addresses can be through the agent 4 or by separate software. The scanning server 8 will select each IP address from the list, connect to the device to be scanned 2 corresponding to the selected IP address, and perform the scanning services.

Once the scanning services are completed, the VPN tunnel 2 is terminated which frees up system resources and allows other networks to connect to the same scanning server.

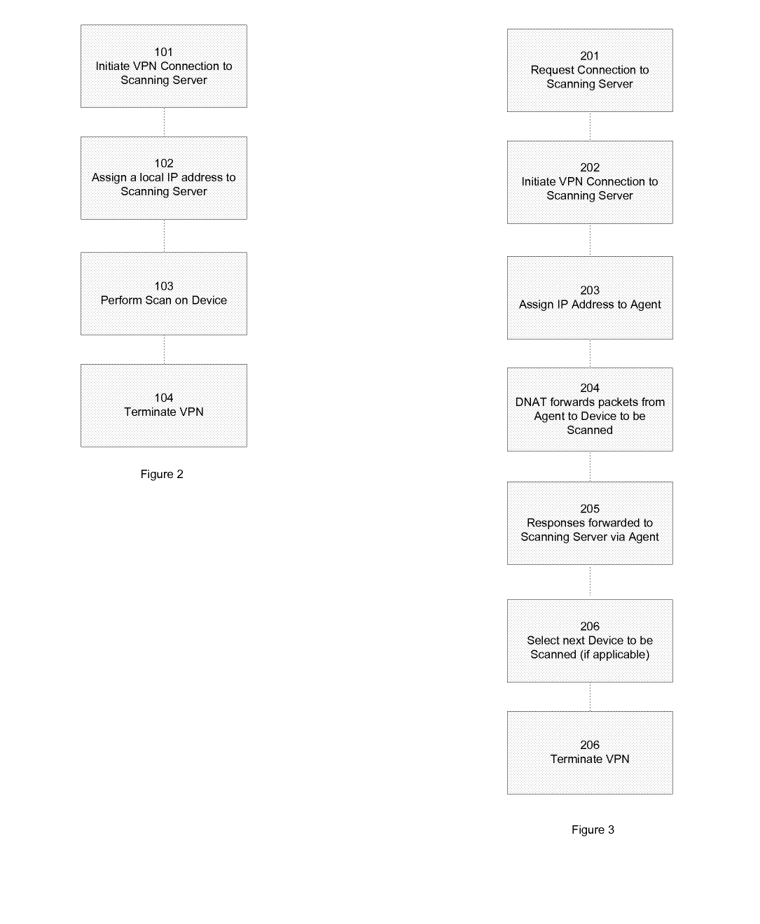

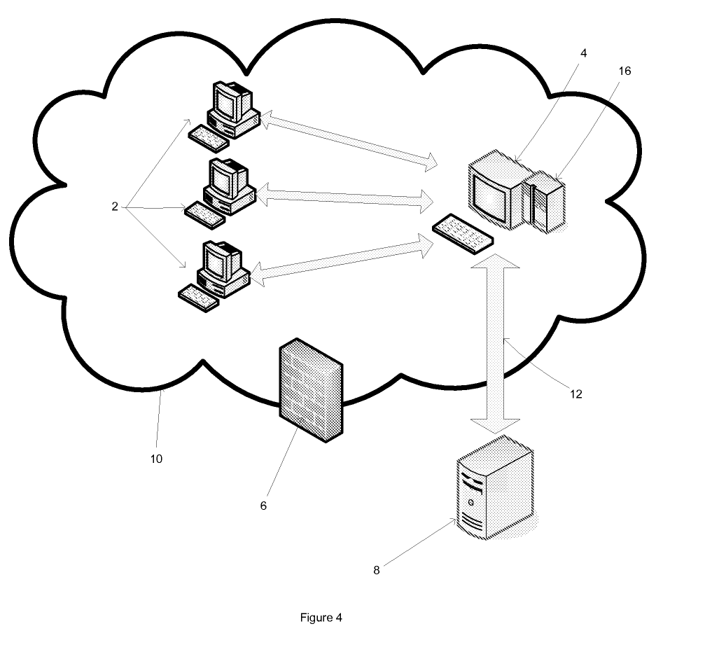

In an alternate embodiment shown in FIG. 3 and 4, in Step 201, the agent 4 first requests connection to the scanning server 8. In Step 202, a VPN tunnel 12 is established in any known manner. The agent 4 in this embodiment includes a destination network address translation module (“DNAT”) 16. In Step 203, the agent 4, rather than the scanning server 8, is assigned an internal IP address that is local to the scanning server 8. This can be done using DHCP, by providing the agent 4 with static IP information, or by having the agent 4 pre-configured with a specific IP address that is an IP address local to the scanning server 8. In Step 204, the agent runs DNAT 16 so that any packets sent by the scanning server 8 to the agent 4 are automatically be forwarded to the device that needs to be scanned 2. In Step 205, replies from the device 2 made in response to the scanning services are forwarded from the device 2 through the agent 4 to the scanning server 8.

If multiple devices 2 are required to be scanned, in Step 206, the DNAT 16 is automatically reconfigured to scan a separate device 2 upon completion of the previous scan. If several devices need to be scanned at the same time, the agent 4 can assume multiple IP addresses that are local to the scanning server 8 and provide DNAT 16 for each device 2. The agent 4 forwards each packet from the scanning server 8 to the appropriate device to be scanned 2. This allows a single agent 4 to be installed on the network 10 and have it serve as the DNAT 16 for the scanning services for every device to be scanned 2.

As in the first embodiment, a list of IP addresses to be scanned can be used by the scanning server 8 to determine which devices 2 on the network 10 need to be scanned.

In step 207, after the scanning is complete, the VPN 12 is terminated to free up network resources.

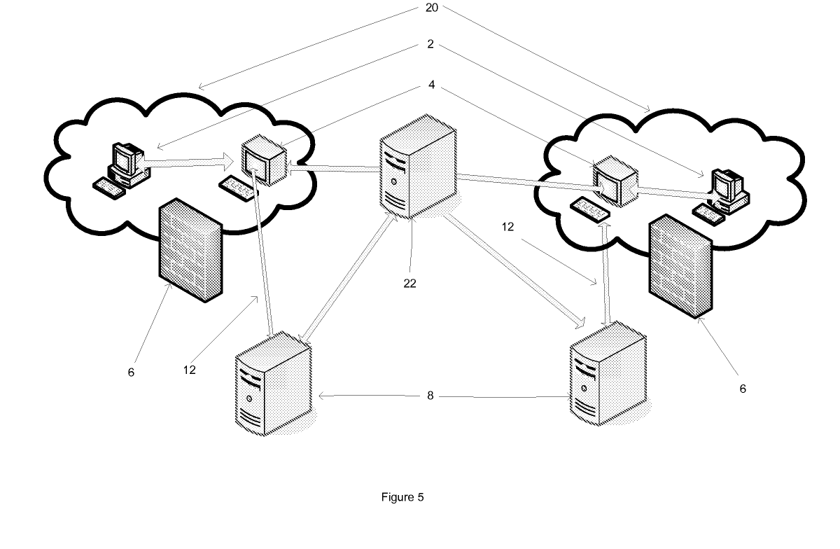

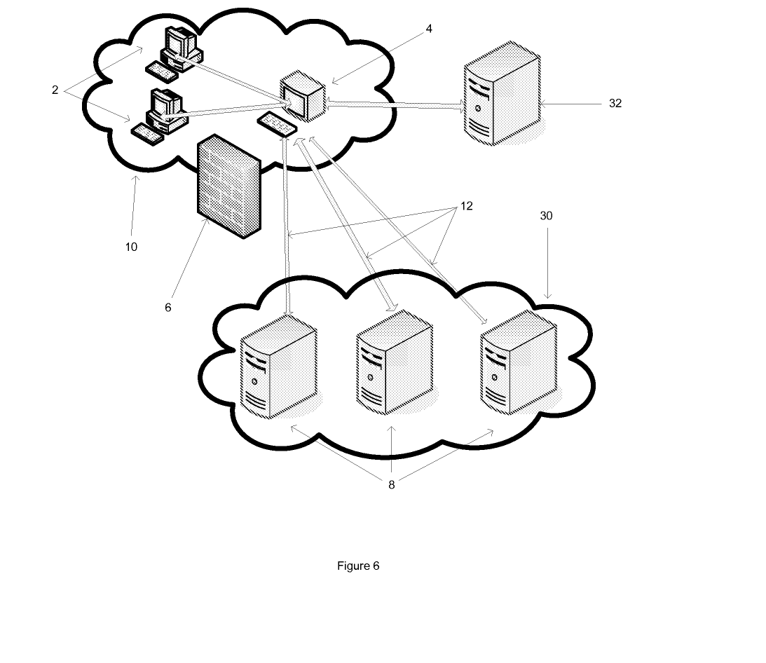

As shown in FIG. 5, the scanning services can also be run in parallel for multiple intranets 20 by having a mediator server 22 automatically select a network scanning server that is currently not performing a scan. The agent 4 on each network 20 connects to the mediator server 22. The mediator server 22 then assigns each network a scanning server 8 and directs the agent 4 to connect to the assigned scanning server. Assignment can be made by having the mediator server 22 check a list of available scanning servers 8 that is stored in a database or available server list. The mediator server 22 then returns connection attributes to the agent 4. The agent 4 uses these attributes to establish a VPN tunnel 12 to each scanning server 8 over which the scanning servers are performed. The VPN tunnel 12 and the scanning services are performed as described with the first and second embodiments described herein.

FIG. 6 shows another embodiment of the invention that allows multiple scanning servers 8 to be used on multiple devices 2 within the local network 10. In this embodiment, a scanning server 8 is selected at random from a pool of scanning servers 30. The agent 4 then attempts to create a VPN tunnel 12 or checks to make sure the selected scanning server 8 is free to do the scanning. If the scanning server 8 is busy with a scan on a separate device or if the VPN tunnel 12 cannot be created for whatever reason, such as the scanning server is disconnected, not available, undergoing maintenance, etc., then the agent 4 will select another scanning server 8 from the pool of scanning servers 30 and attempt another connection. This process continues until a scanning server 8 is successfully selected and connected to by the agent 4 using a VPN tunnel 12. The scanning services are then performed over the VPN tunnel 12.

Optionally, the agent 4 could automatically bring up the scanning services on virtual private server (“VPS”) 32 and then have the agent 4 connect to the VPS. The VPS then selects the scanning server 8 from the pool of scanning servers 30 for the agent 4. The agent 4 then establishes the VPN tunnel 12 through either the VPS 32 or directly to the scanning servers 8 in the pool of scanning servers 30.

Optionally, if several devices need to be scanned 2, then the total scanning speed may be increased by having a mediator server 22 or the agent 4 assign each scanning server 8 connected to the network a separate set of IP addresses. Each scanning server 8 would then take care of scanning the devices 2 associated with the assigned set of IP addresses. Multiple VPN tunnels 12 can be created between the agent 4 and the scanning servers 8 in the pool of scanning servers 30 in order to allow each scanning server 8 access to the local network 10.

In order to increase the speed of performing the scans, the agent 4 can be configured to connect to multiple scanning servers 8 which run simultaneous scans on the various devices to be scanned 2. If the first embodiment is being used to connect to the scanning servers 8, then each separate scanning server in the pool of scanning servers 30 is assigned its own intranet IP address by the agent 4.

If the second embodiment is being used to connect to the scanning servers 8, then each scanning server 8 uses the DNAT 16 that is part of the agent 4 to act as part of the local network 10. The DNAT 16 would forward the scanning server queries and responses made to the appropriate device to be scanned 2.

In addition, the previous embodiments may be set up in an enterprise situation where a plurality of agents 4 exist over many networks 10. Some networks may have more than one agent. The plurality of agents 4 connects via VPN tunnels 12 to a plurality of scanning servers 8. This may be one agent per server, multiple servers per agent, or multiple agents per server. The scanning servers 8 then perform the scanning over the VPN tunnels 4 to multiple devices 2 on the networks. Such an embodiment works well for mass scanning of devices and can be created using a pool of servers.

The invention is not restricted to the details of the foregoing embodiments. The invention extend to any novel one, or any novel combination, of the features disclosed in this specification (including any accompanying claims, abstract and drawings), or to any novel one, or any novel combination, of the steps of any method or process so disclosed.

What is claimed is:

1. A method of performing scanning services on a device comprising:
establishing at least one VPN tunnel to a scanning server using an agent; and
performing a vulnerability scan on a device to be scanned over the VPN tunnel.

2. A method according to claim 1, where the agent is a program running on the device to be scanned.

3. A method according to claim 1, where the agent is a program running on a computer on the same network as the device to be scanned.

4. A method according to claim 1, further comprising assigning the scanning server an IP address that is part of the network that is local to the device to be scanned.

5. A method according to claim 1, further comprising assigning the scanning server an IP address that is part of the network that is local to the agent.

6. A method according to claim 1, further comprising terminating at least one VPN tunnel after the vulnerability scan is complete.

7. A method according to claim 1, further comprising assigning the agent an IP address that is local to the scanning server.

8. A method according to claim 7, further comprising having the agent configured to run DNAT.

9. A method according to claim 8, further comprising sending queries and responses from the scanning server and the device to be scanned through DNAT.

10. A method according to claim 7, further comprising having DNAT handle at least one communication between the scanning server and agent.

11. A method according to claim 1, where at least one VPN tunnel is automatically initiated at a set time as specified in the agent.

12. A method according to claim 1, where at least one VPN tunnel is created by the agent using settings and instructions stored on a scanning server.

13. A method according to claim 1, where at least one VPN tunnel is created by the agent using settings and instructions stored on a computer separate from the scanning server.

14. A method according to claim 1, where at least one VPN tunnel is created by the agent for multiple networks using a mediator server that automatically selects the scanning server from a pool of scanning servers.

15. A method according to claim 15, where at least one VPN tunnel is established through a virtual print server.

16. A method of performing scanning services on a plurality of devices to be scanned comprising:
establishing at least one VPN tunnel to at least one scanning server using at least one agent; and
performing a vulnerability scans on the plurality if devices to be scanned over the VPN tunnel.

17. A method according to claim 16, where a list of IP addresses is used to determine the plurality of devices to be scanned.

18. A method according to claim 16, further comprising terminating at least one VPN tunnel after the vulnerability scans are complete.

19. A method according to claim 16, further comprising assigning at least one scanning server an IP address that is part of a network that is local to at least one agent.

20. A method according to claim 16, further comprising assigning at least one agent an IP address that is local to at least one scanning server.

21. A method according to claim 20, further comprising having at least one agent configured to run DNAT.

22. A method according to claim 21, further comprising sending queries and responses from at least one scanning server and the plurality of devices to be scanned through DNAT.

23. A method according to claim 21, further comprising having DNAT handle at least one communication between the scanning server and at least one of the plurality of devices to be scanned.

24. A method according to claim 16, where at least one VPN tunnel is automatically initiated at a set time as specified in at least one agent.

25. A method according to claim 16, where at least one VPN tunnel is created by at least one agent using settings and instructions stored on at least one scanning server.

26. A method according to claim 16, where at least one VPN tunnel is created by at least one agent using settings and instructions stored on at least one computer separate from at least one scanning server.

27. A method according to claim 16, where at least one VPN tunnel is created for at least one agent over multiple networks using a mediator server that automatically selects at least one scanning server from a pool of scanning servers.

28. A method according to claim 16, where at least one VPN tunnel is established through a virtual print server.

29. A method according to claim 16, where a plurality of VPN tunnels are created between at least one agent and a plurality of scanning servers where the plurality of scanning servers are configured to run vulnerability scans simultaneously.

30. A system for performing scanning services comprising:
an agent;
at least one device to be scanned on a network;
a scanning server outside of the network;
a network security device;
at least one VPN tunnel between the agent and a scanning server outside of the network; and
means for performing vulnerability scanning on the at least one device to be scanned on the network.

31. A system according to claim 30, further comprising a means of performing DNAT.

32. A system according to claim 30, further comprising a mediator server.

33. A system according to claim 30, further comprising a virtual private server.

34. A system for performing scanning services comprising:
At least one agent;
at plurality of devices to be scanned on at least one network;
at least one scanning server outside of the network;
at least one network security device;
at least one VPN tunnel between at least one agent and at least one scanning server outside of at least one network; and
means for performing vulnerability scanning on the at least one device to be scanned on at least one network.

35. A system according to claim 30, further comprising a means of performing DNAT.

36. A system according to claim 30, further comprising at least one mediator server.

37. A system according to claim 30, further comprising at least one virtual private server.

38. A system for performing scanning services comprising:
a plurality of agents;
a plurality of devices to be scanned located on multiple networks;
a plurality of scanning servers where at least one scanning server is located outside of a network containing at least one device to be scanned;
at least one network security device protecting at least one of the multiple networks;
a plurality of VPN tunnels between the plurality of agents and plurality of scanning servers; and
means for performing vulnerability scanning over the plurality of VPN tunnels.

39. A system according to claim 30, further comprising a means of performing DNAT.

40. A system according to claim 30, further comprising at least one mediator server.

41. A system according to claim 30, further comprising at least one virtual private server.
